(19) United States
(12) Patent Application Publication
(10) Pub. No.: US 2001/0034831 A1
(43) Pub. Date: Oct. 25, 2001

(54) Method and apparatus for providing internet access to client computers over a lan

(76) Inventors: Jose C. Brustoloni, Westfield, NJ (US); Juan Alberto Garay, West New York, NJ (US)

Correspondence Address: THOMASON, MOSER AND PATTERSON L.L.P., 595 SHREWSBURY AVE, FIRST FLOOR, SHREWSBURY, NJ, 07702, US

(21) Appl. No.: 09/765,847

(22) Filed: Jan. 19, 2001

Related U.S. Application Data
(60) Provisional application No. 60/198,547, filed on Apr. 19, 2000.

(51) Int. Cl. H04L 9/00

(52) U.S. Cl. 713/151

(57) ABSTRACT

A method and associated apparatus for providing access to the Internet or other network is described, where clients may connect their own computers to a LAN supplied by the access provider, who may charge for such access and may use security protocols for denying access to unauthorized or nonpaying users, and where the contract between client and access provider may be established at the point of access, independently of a previous relationship between both parties, and may have term as short as the client desires. in one aspect, the access provider may use the access services of another access provider and may use Network Address Translation (NAT) to reduce access costs. The client may select the desired level of security, usage metrics, usage limits, and payment options, and may monitor and control his or her usage. In one aspect, the client does not need to reveal his or her identity to the access provider. In one aspect, the access provider may present to the client a certificate signed by a Certification Authority that ensures that the access provider is bona fide and secure. In one aspect, the access provider gives the client a receipt that the client may use to recover from client or access provider failures.

### CONTINUATION INFORMATION

This disclosure is claiming priority to commonly assigned U.S. provisional patent application, Ser. No. 60/198,547, filed on Apr. 19, 2000, and entitled “MicroISPs: Providing Convenient and Low-Cost High-Bandwidth Internet Access” (Incorporated herein by reference).

### BACKGROUND OF THE DISCLOSURE

1. Field of the Invention

The present invention relates to computer networks, and more particularly to Internet service providers.

2. Description of the Background Art

Client computers typically connect to a network such as the Internet via service providers (SP), e.g., an Internet Service Provider. The typical SP contract lasts at least a month and often many months or years. In the conventional SP architecture 100, illustrated in FIG. 1, each client computer uses an individual access link connecting the computer to the SP's Point of Presence (POP). The conventional SP architecture 100 includes one or more client computers 104a to 104d, the respective dial-up lines using the Public-Switched Telephone Network (PSTN) 102, and an SP's POP 106. The POP 106 may include an access router 108, one or more servers 110, a backbone router 112, and a link 114 that connects to the Internet 115. Dial-up telephone lines allow Internet access wherever there is a phone, but dial-up lines may be unavailable, inconvenient, expensive to use, and also provide low bandwidth.

SP architectures similar to the one illustrated in FIG. 1 can be applied to higher bandwidth access technologies, such as T1 or other dedicated telephone lines, Integrated Services Digital Network (ISDN) lines, Digital Subscriber Lines (DSL), and Hybrid Fiber-Coaxial (HFC) cable systems. However, these higher bandwidth technologies are customarily available only at locations where the client installs them, e.g., at one or more office locations or at a home location.

The conventional SP architecture shown in FIG. 1, and its higher-bandwidth variations, have several shortcomings. The access link costs for the Internet connection are high. Mobility support for client computers is poor, especially for client computers requiring higher access bandwidths. Although wireless phones may offer a convenient mobile connection to client computers, wireless calls may be expensive and may provide relatively low bandwidth.

Mobile clients may prefer to use a cybercafe, rather than connect to an SP. Typically, cybercafes lease Internet-connected desktop or laptop computers to clients. Cybercafes allow short-term service contracts. However, cybercafes require a considerable investment by the operator because of the computers and space required. Moreover, many clients may find their own computer more familiar and secure than are a cybercafe's computers.

Therefore, there is an unsatisfied need for secure, low-cost, high-bandwidth Internet access at locations that are convenient for mobile clients.

### SUMMARY OF THE INVENTION

The invention relates generally to providing Internet access services via a LAN. More particularly, a method and associated apparatus is described for providing paid access accessing, via a local area network (LAN), a micro-service provider (μSP). The μSP establishes a secure tunnel with each client, preventing unauthorized or nonpaying users from gaining service. Clients negotiate a contract for network usage with said μSP. Contracts may have term as short as desired. Clients may pay for service at the point of service, and no relationship between client and μSP is necessary before or after the contract. Clients access said computer network via said μSP according to said contract.

### BRIEF DESCRIPTION OF THE DRAWINGS

The teachings of the present invention can be readily understood by considering the following detailed description in conjunction with the accompanying drawings, in which:

FIG. 1 shows one embodiment of a conventional Service Provider (μSP) architecture that provides access to a computer network, such as the Internet;

FIG. 2 shows one embodiment of a micro Service Provider (μSP) architecture, object of the present invention;

FIG. 3 shows the formats of packets secured using IPsec protocols;

FIG. 4A shows a state diagram of one embodiment of possible contract states to be used in the μSP architecture of FIG. 2;

FIG. 4B shows a state diagram of one embodiment of the possible states underlying the outstanding contract state of FIG. 4A;

FIG. 4C shows a state diagram of one embodiment of the possible states underlying the bound outstanding contract state of FIG. 4B;

FIG. 5 shows a state diagram of one embodiment of the IP address states; and

FIG. 6 shows a flow chart of one embodiment of a method performed between the client computer and the μSP router/server of FIG. 2.

To facilitate understanding, identical reference numerals have been used, where possible, to designate identical elements that are common to the figures.

### DETAILED DESCRIPTION

### μSP Architecture

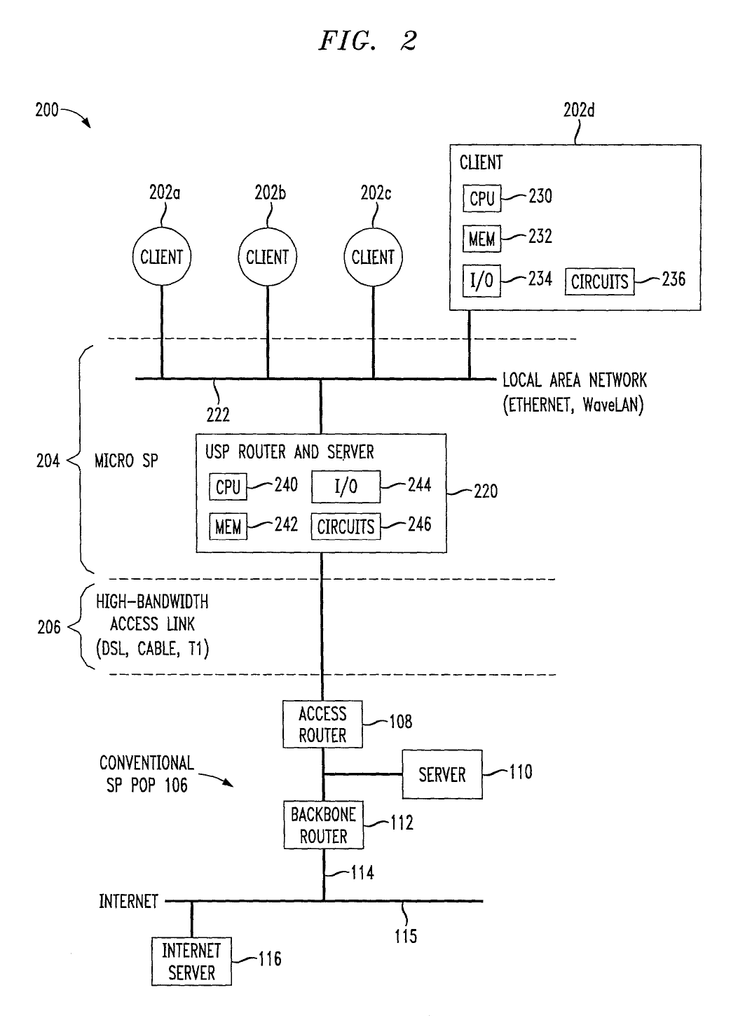

One embodiment of a micro-SP (μSP) architecture 200 that is suitable for providing access to the Internet or other computer networks at such locations as airports, hotels, conference centers, cafes, and office or apartment buildings, is here described relative to FIG. 2.

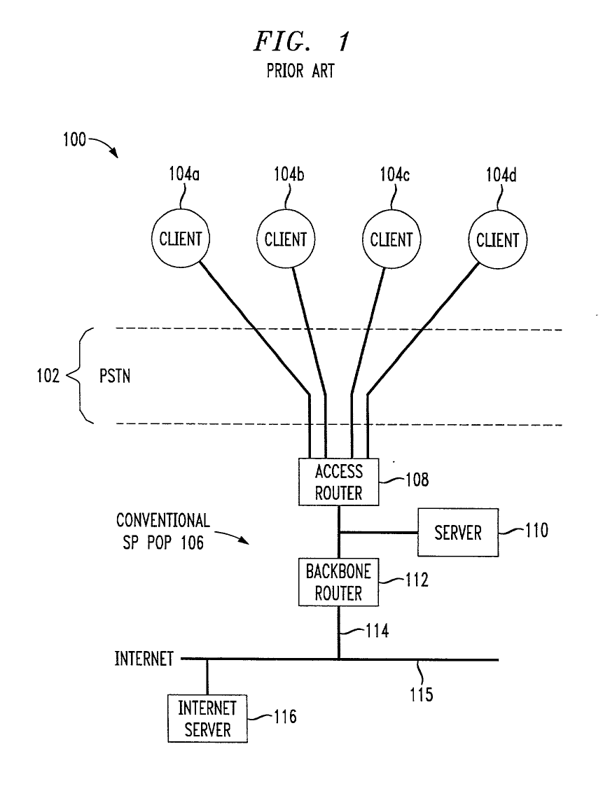

The μSP architecture 200 comprises one or more client computers 202a to 202d, a μSP LAN 222, a μSP router and server 220, and an access link 206 to a conventional SP POP 106. The POP 106 may include an access router 108, one or more servers 110, a backbone router 112, and a link to the Internet 114, as also shown in FIG. 1.

Each client computer 202a to 202d is preferably configured as a distinct computer. The components of each client computer are indicated by an exemplary client computer 202d. The exemplary client computer 202d shown in the embodiment of FIG. 2 comprises a central processing unit (CPU) 230, a memory 232, a circuit portion 236, an input output interface (I/O) 234, and a bus not shown. The client computer 202d may be a general-purpose computer, a microprocessor, a microcomputer, or any other suitable type of computer. The CPU 230 performs the processing and arithmetic operations associated with the client computer

The memory 232 includes random access memory (RAM) and read only memory (ROM) that together store the computer programs, operands, operators, system configurations, and other computer parameters. The bus provides for digital information transmissions between CPU 230, circuit portion 236, memory 232, and I/O 234. The bus also connects I/O 234 to the portions of the μSP architecture 200 that either receives digital information from, or transmits digital information to, the client computer 202d.

I/O 234 provides an interface to control the transmissions of digital information between each of the components in client computer 202d. I/O 234 also provides an interface between the components of the client computer 202d and different portions of the μSP architecture 200. Circuit portion 236 comprises all of the other user interface devices (such as display and keyboard), system devices, and other accessories associated with the client computer 202d.

The μSP LAN 222 may be, e.g., an Ethernet, Token Ring, or a wireless LAN, such as BLUETOOTH® (a registered trademark of TELEFCHAKTIEBOLAGET LM ERICSSON, of Sweden) or IEEE 802.11, or any other LAN or combination of LANs in use. The LAN 222 and the μSP router/server 220 are maintained and operated by the owner of the μSP 204. The architecture and protocols utilized by the μSP architecture 200 ensure that the μSP owner can control and secure the connection of client computers 202a to 202d to the μSP router/server 220 via a LAN 222.

The μSP router/server 220 shown in the embodiment of FIG. 2 may comprise a central processing unit (CPU) 240, a memory 242, a circuit portion 246, an input output interface (I/O) 244, and a bus not shown. The μSP router/server 220 may be a general-purpose computer, a microprocessor, a microcomputer, or any other suitable type of computer, router, switch, or network gateway. The CPU 240 performs the processing and arithmetic operations associated with the μSP router/server 220.

The memory 242 includes random access memory (RAM) and read only memory (ROM) that together store the computer programs, operands, operators, system configurations, and other computer parameters. The bus provides for digital information transmissions between CPU 240, circuit portion 246, memory 242, and I/O 244. The bus also connects I/O 244 to the portions of the μSP architecture 200 that either receives digital information from, or transmits digital information to, the μSP router/server 220.

I/O 244 provides an interface to control the transmissions of digital information between each of the components in μSP router/server 220. I/O 244 also provides an interface between the components of the μSP router/server 220 and different portions of the μSP architecture 200. Circuit portion 246 comprises all of the other user interface devices (such as display and keyboard), system devices, and other accessories associated with the μSP router/server 220.

The μSP router/server 220 connects the LAN 222 of the μSP 204 to a conventional SP POP 106 via a shared access link 206. The shared access link 206 typically has high bandwidth and may be, e.g., a Digital Subscriber Line (DSL), T1, or cable.

The μSP owner may charge clients 202a to 202d for access to the Internet or other network access provided by the μSP. The μSP architecture 200 reduces each client's access costs by amortizing the cost of the shared access link 206 among all clients 202a to 202d. Client computers 202a to 202d access the μSP via a low-cost, high-bandwidth LAN 222. The bandwidth that is dynamically allocated to each client computer by the μSP architecture may be similar to that enjoyed by many users at work, and is envisioned to be superior to that afforded at home by a dial-up public switched telephone network (PSTN) line.

The μSP architecture 200 supports a variety of payment methods, both offline (e.g., cash, credit card, or billing to a hotel room account) and online (e.g., eCASH® (a registered trademark of PRENET Corporation of Portland, Oreg.), SECURE ELECTRONIC TRANSACTIONS (SET)™, IBM MICRO PAYMENTS™, or MILLICENT™ (a registered trademark of COMPAQ INFORMATION TECHNOLOGIES GROUP of Houston, Tex.)). The μSP architecture supports the needs of transient, i.e., mobile, owners of client computers 202a to 202d because μSP contracts can be short-term, such as a fraction of an hour or more. The low investment necessary to set up the μSP and the potential profitability encourage widespread deployment.

### μSP Protocol

The μSP architecture 200 includes a protocol for communication between a plurality of client computers 202a to 202d and the μSP router/server 220 so the client computer can communicate with the Internet or other network. The network access may be provided for as brief a duration as desired and therefore may be particularly suitable for such locations as airports, hotels, and conference centers. The server and router components of the μSP router/server 220 can either be implemented separately or in combination.

The μSP architecture may use standard LAN cards that many owners of client computers 202a to 202d already own, e.g., cards for Ethernet LANs, Token Ring LANs, or 802.11 wireless LANs. To guarantee that only paying clients gain access and to provide security on the LAN, the μSP architecture 200 may use the Internet Security (IPSec) protocol suite, standardized by the Internet Engineering Task Force (IETF). IPSec is supported by most current operating systems, including WINDOWS 2000® (registered trademark of the MICROSOFT CORPORATION of Redmond, Wash.) and LINUX™. The embodiment here described uses IPSec, but the μSP architecture may, alternatively, use other security protocols, such as Point-to-Point Tunneling Protocol (PPTP).

An overview of one embodiment of the μSP architecture, protocol, and its phases is now provided. The μSP protocol has a plurality of phases including networking configuration, secure tunnel establishment, control channel establishment, contract establishment and binding, usage metering, and settlement. Variations in the μSP design and the performance of a prototype implementation are also described.

Phase 1. Networking configuration: Before a client's computer can communicate with the μSP, some of its networking parameters need to be configured, such as the IP addresses of the client's computer and of the default router. μSP uses the standard Dynamic Host Configuration Protocol (DHCP) to achieve this client computer configuration.

When each client computer 202a to 202d boots or restarts, it broadcasts DHCP packets over LAN 222 requesting configuration parameters. The μSP router/server 220 replies with the appropriate parameters, including network mask and broadcast address, IP addresses of the client's computer and of the default router and possibly, the IP addresses of a Domain Name System (DNS) server, a network time protocol (NTP) server, and a line printer server. The μSP protocol uses DHCP's dynamic IP address allocation so the IP addresses assigned to a client's computer remain valid only during a specified lease time. Client computers must periodically renew their leases to preserve their IP addresses. Expired IP addresses may be reused by other client computers 202a to 202d.

DHCP simplifies the μSP network configuration. A client may link their computer 202a to 202d to the μSP LAN 222 that is located in an airport lounge or conference room, reboot the computer, and automatically be configured to access the Internet using the μSP. DHCP is supported by most current operating systems, including WINDOWS 2000®, WINDOWS NT®, and LINUX®.

Phase 2. Secure tunnel establishment: μSP establishes a secure tunnel with each client. The tunnel guarantees that all packets received by the μSP from a certain IP address correspond to the same client. The secure tunnel may be implemented, e.g., using IPSec's Authentication Header (AH) protocol in tunnel mode to authenticate client packets. When establishing an IPSec tunnel, a client may present a self-signed certificate to the μSP. Such certificates do not prove the identity of the client to the μSP. The identity of the client is typically immaterial to the operator of the μSP 204, provided that the client pays up front for the μSP services. Therefore, the use of a self-signed certificate by the client is satisfactory. On the other hand, before paying, users of client computers 202a to 202d may want to verify that they are communicating with a bona fide μSP. Therefore, the μSP must present to the client computer a certificate issued by a recognized μSP Certifying Authority (CA).

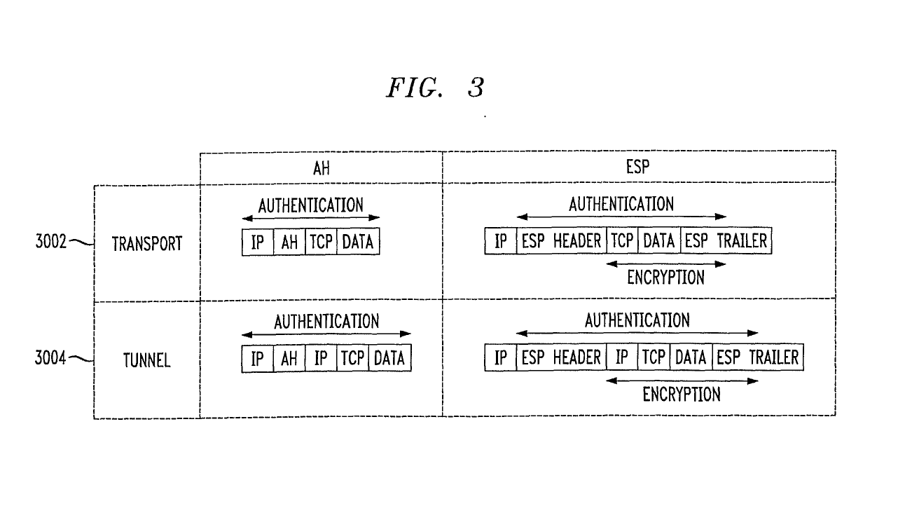

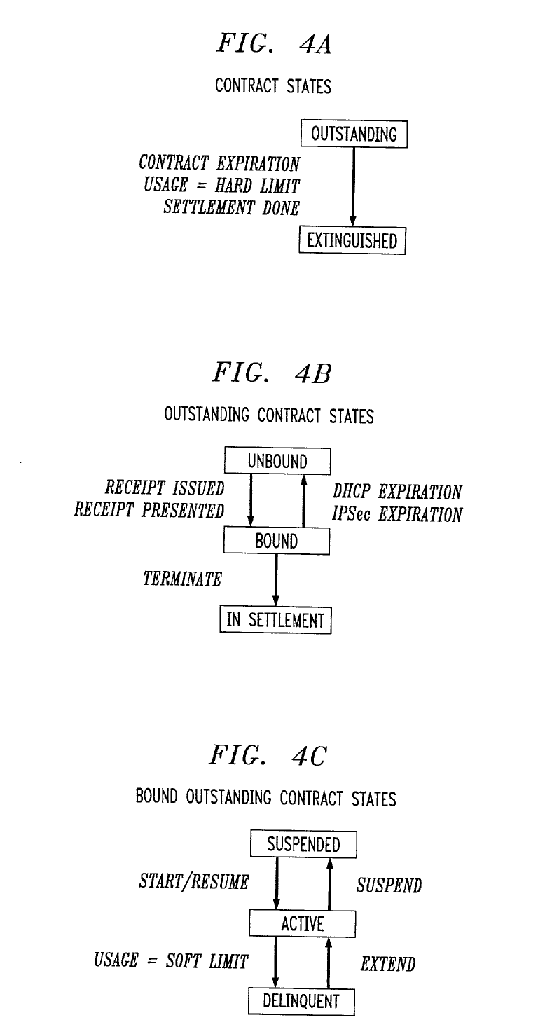

IPSec defines two protocols for secure data communication, AH and Encapsulating Security Payload (ESP). These protocols are implemented at the network layer and therefore do not require modifications in client applications. AH can provide authentication of packet origin, proof of integrity of packet data, and protection against packet replay. ESP can provide, in addition to AH's services, encryption of packet data and limited traffic flow confidentiality. However, unlike AH's authentication, ESP's does not include the packet's source and destination IP addresses. AH and ESP can be used in either transport or tunnel mode, as illustrated as 3002 and 3004 in FIG. 3. Transport mode provides end-to-end security between the packet's source and destination. In contrast, tunnel mode encapsulates packets and thus provides security between the nodes where the packet is encapsulated and decapsulated.

The μSP protocol may use the AH protocol in tunnel mode to authenticate all packets received from a client's IP address, guaranteeing that the respective address is always used by the same client while the address is allocated or bound to a contract. If the client so selects, the μSP protocol may also use AH in tunnel mode to authenticate all packets sent or forwarded to the client. In this case, after the tunnel is established, the client may verify the networking configuration that was performed insecurely by DHCP in phase 1. The authenticated tunnel and the verification of the networking configuration can limit DHCP- or Domain Name System (DNS)-based security attacks against client computers on the μSP's LAN 202 by third parties. Another option available to owners of client computers 202a to 202d is to use ESP encryption for all packets sent to or received from the client's address. This option preserves privacy on the μSP's LAN. The authentication and encryption options are most useful when client computers 202a to 202d are accessing insecure sites on the Internet. A client may not need these options, e.g., when they establish another IPSec tunnel within the client's μSP tunnel to communicate securely with an IPSec gateway into the Intranet of the client's employer. In the latter case, the nested tunnel may already provide all necessary authentication and encryption.

The μSP protocol may use the IPSec Internet Key Exchange protocol (IKE) to establish security associations that define the algorithms and cryptographic keys used by AH and ESP. Security associations have a specified lifetime, after which they are terminated and need to be replaced. The μSP protocol uses IKE authenticated with signatures. The client computer is the initiator in the μSP protocol. The μSP and the client computer perform a Diffie-Hellman key exchange, as described in the article by W. Diffie and M. E. Hellman, “New Directions in Cryptography,” in Transactions on Information Theory, IEEE, IT-22: 644-654, 1976 (incorporated herein by reference), for securely establishing a shared secret code from which AH and ESP keys are derived. Each party then authenticates the other by verifying the other's signature on a message containing the other's certificate. Each party's certificate contains that party's public key, which is necessary for verifying that party's signatures. A party's certificate also contains that party's identity and is itself usually signed by a CA whose public key is widely known, so that any party can verify the certificate. Certificate formats are defined, e.g., in the X.509 standard (Incorporated herein by Reference).

Authentication is necessary to limit “person-in-the-middle” attacks, where an intruder would pretend to be the client computer when communicating with the μSP, and to be the μSP when communicating with the client computer. Therefore, μSPs must present certificates signed by a recognized μSP CA, which maintains registration procedures appropriate for such certification. In a Public Key Infrastructure (x.509 or PKIX)-based implementation, these certificates would contain a policies extension with explicit-text user notice. This notice should be displayed to the client and informs the location and type of LANs supported by the μSP. On the other hand, the μSP does not really need to authenticate the client's identity in this phase; the μSP's only requirement is that the client pay for the μSP usage in phase 4 of the protocol, and that no other client be able to use that payment to gain service. Therefore, the μSP can be configured to accept self-signed client certificates in IKE exchanges. Using such certificates, the identity of owners of client computers 202a to 202d can remain anonymous.

IPSec security policies are defined in a Security Policy Database (SPD) per network interface. Each SPD entry specifies a selector and a rule. Selectors may match, e.g., packets that have a certain protocol and source and destination IP addresses and port numbers. Ranges and wild cards are allowed for these values. Actions may be to drop the packet, bypass IPSec, or apply specified IPSec protocols to the packet. The SPD of the LAN interface of a μSP router/server 220 is configured, in the incoming case, to bypass IPSec in the cases of DHCP and IKE packets destined to the μSP, to perform AH and optional ESP processing to packets whose source address is bound (phase 4) to an active contract or whose destination is the μSP, and to drop remaining packets. In the outgoing case, the SPD is configured to bypass IPSec in the cases of DHCP and IKE packets whose source is the μSP, to bypass IPSec or apply AH or ESP processing to packets whose source is the μSP or whose destination address is bound to an active contract, and to drop remaining packets. While a client's computer is accessing a μSP, the SPD of the computer's LAN interface is similarly configured, with the incoming and outgoing cases reversed.

Though the above describes phase 2 as utilizing IPSec protocols, it is envisioned that the point to point protocol (PTPP) may be used instead of IPSec to establish the secure tunnel of phase 2.

Phase 3. Control channel establishment: The μSP protocol requires a secure control channel to send the μSP's price list to the client before payment, and a receipt after payment. Clients also use this control channel to control their Internet usage. If the tunnel established in the previous phase uses ESP, the control channel may be simply a Transmission Control Protocol (TCP) connection; otherwise, the control channel uses the Transport Layer Security (TLS) protocol.

The control channel should guarantee message authenticity and privacy in both directions between the client computer 202a to 202d and the μSP router/server 220. Privacy is needed, e.g., to prevent the eavesdropping of receipts and the use of receipts by nonpaying clients. If the client selected the privacy option in phase 2, all communication over the client's tunnel is already secured in both directions by ESP. Therefore, the client establishes the control channel by simply opening a TCP connection to a well-known port in the μSP router/server. Otherwise, the tunnel established in phase 2 does not provide all the required security, i.e., the tunnel only authenticates client packets to the μSP 204. Therefore, the client employs the TLS protocol for establishing a secure control channel over the client's tunnel. The principals of the TLS channel are guaranteed to be the same as those of the AH tunnel. On the one hand, the client authenticates the μSP router/server 220 using the μSP's certificate, signed by a μSP CA. On the other hand, the μSP router/server has a guarantee that the TLS and AH clients are one and the same, because TLS packets are sent through the AH tunnel.

Phase 4. Contract establishment and binding: Contract establishment and binding relates to how a contract between the μSP and the client is established, in offline and online cases, and how the IP address assigned to the client in phase 1 and secured in phase 2 is bound to the client's contract in phase 4 of the μSP protocol.

In this phase, 1) the μSP presents to a client 202a to 202d a list of options for service and their respective prices, 2) the client selects the desired options, 3) the client makes a deposit payment, and 4) the μSP gives a receipt to the client. This phase is skipped entirely if the client's computer already has the receipt for an outstanding contract, and the client is reconnecting to the μSP after turning his or her computer off. Steps 1 to 3 are skipped if the client presents a valid password, received from the μSP in offline processing of those steps, such as payment by cash, credit card, or billing to a hotel room account. Online payment will necessarily use the tunnel established in phase 2, and therefore can be securely bound to it.

The four steps to establish the contract are now elaborated:

1. μSP offer: The μSP presents to the client a contract form containing a serial number, the current date and time, available service options, including: a) acceptable usage metrics, such as elapsed or usage time, or number of bytes or packets transmitted, and their respective prices, and b) acceptable payment methods. Offline payment methods may include cash, credit card, or billing to an account, such as a hotel room account. Online payment methods may include eCASH®, SET®, IBM MICRO PAYMENTS®, or MILLICENT®. A contract is always subject to an expiration time. Prices may depend, for example, on whether the client has selected the privacy option of phase 2, on the amount of usage, on the payment method selected, and on the current or anticipated μSP load.

2. Client request: The client completes the form indicating the desired usage metrics, soft and hard usage limits, and payment method. In offline cases, if the payment method is not cash, the client physically signs the form.

3. Client deposit: The client employs the selected payment method to deposit with the operator of the μSP an amount equal to the selected hard usage limit. If the payment method is credit card or SET®, this deposit is implemented by an authorization transaction. In certain online cases that do not include SET® or eCASH®, the μSP may need to allow the client to communicate directly with external servers before paying. In IBM MICRO PAYMENTS®, for example, the client may need to contact his or her issuer to obtain the client's daily certificate, which is necessary for making payments. As another example, in MILLICENT®, the client may need to contact his or her broker to convert broker scrips into μSP scrips. Scrips are MILLICENT's® merchant-issued payment instruments. Modifications in IPSec's SPDs may be necessary to enable the latter payment methods, e.g., permitting client communication with certain supported issuers or brokers for a limited time.

4. μSP receipt: The μSP gives to the client a copy of the contract and password for offline cases, or a receipt for online cases. The client commits the receipt to stable storage. The receipt is a data structure that includes the contract's serial number, date and time, expiration, selected usage metrics and limits, and payment parameters. The μSP authenticates the receipt with a Message Authentication Code (MAC). MAC computation uses a secret key with, e.g., the DES cipher-block chained checksum (DESMAC), keyed DES in CBC mode with an MD5 checksum (keyed-MD5), or the HMAC algorithm.

Phase 4 of the μSP protocol is executed as follows. If the client's stable storage contains the receipt of an outstanding contract, the client sends the receipt over the control channel to the μSP. The μSP then verifies that the contract is still outstanding, is not bound to an IP address, and is not being settled. The μSP then binds the contract with the client's IP address, concluding this phase. Otherwise, if the client sends over the control channel the password of an unbound outstanding offline contract, the μSP binds the contract with the client's IP address and returns the corresponding receipt. The client then commits the receipt to stable storage, concluding this phase. Otherwise, the client sends over the control channel a request for online contract establishment, triggering the four steps described above. The contract is bound to the client's IP address in step 4.

Phase 5. Usage metering: Until a client's Internet (or other network) usage reaches the hard limit selected in phase 4, the client can send or receive packets using the μSP. To monitor and control the usage, the client may exchange messages with the μSP, using the control channel established in phase 3. These messages may, for example, suspend, resume, or terminate service.

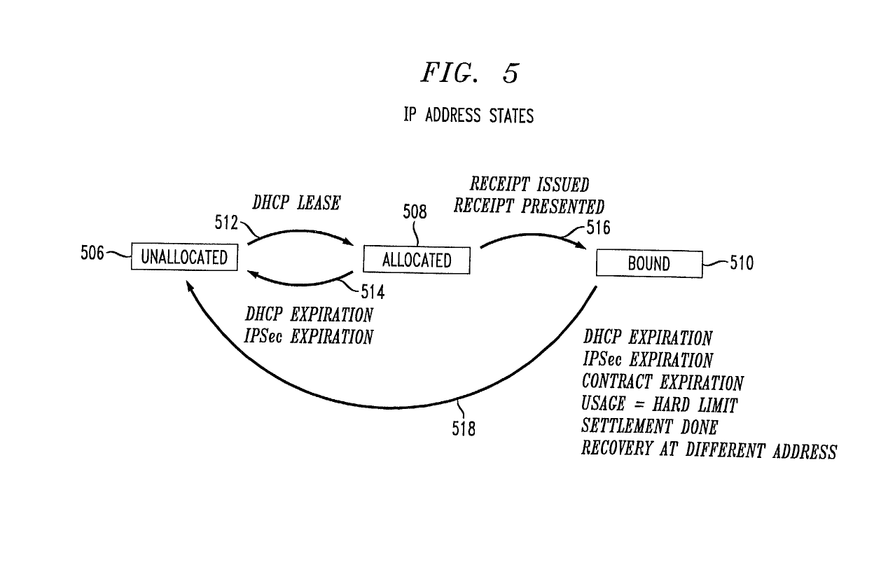

An IP address can be in the unallocated 506, allocated 508, or bound to a contract 510 states, as shown in FIG. 5. IP addresses are initially unallocated. An unallocated IP address becomes allocated when DHCP allocates it to a client's computer, as represented by arrow 512. An allocated IP address becomes unallocated again if the client's computer allows the respective DHCP lease or IPSec security association to expire, as represented by arrow 514. An allocated IP address becomes bound to a contract when the receipt is issued or the receipt is presented, as represented by arrow 516. A bound IP address becomes unallocated when the respective contract becomes unbound or extinguished, or: 1) a client on a different IP address presents the contract's receipt on phase 4 of the μSP protocol; and 2) the μSP repeatedly warns the bound IP address but the bound IP address does not respond, as represented by arrow 518. The latter situation occurs when the client's computer crashes and recovers on a different address.

The μSP meters a contract's usage time only while the contract is active. The μSP router forwards to or from the Internet and meters the number of bytes or packets only of packets that use an IP address bound to an active contract. The μSP also allows packets whose source or destination is the μSP.

Phase 6. Settlement: When service to a client terminates, the net amount paid by the client should be equal to his or her actual usage. If the deposit of phase 4 is greater than the net amount, the client may be due a refund. This settlement is performed in this final phase.

If the client lets the contract expire or uses the contract fully to its hard limit, the μSP retains the whole deposit. If the payment method is credit card or SET, the μSP automatically performs a settlement transaction for that value. On the other hand, if the usage is below the hard limit, an adjustment or refund is necessary, and will be processed according to the payment method. In offline cases other than cash, the client physically signs a new form. In the credit card and SET cases, a settlement transaction for the value of the actual usage is performed. In the cash, eCASH®, and MILLICENT® cases, a refund is returned to the client. In the cases of offline billing to an account and of IBM MICRO PAYMENTS®, the μSP simply adjusts its billing records.

### Network Address Translation (NAT)

The μSP protocol has to allocate one IP address per contract that is bound or in settlement. In order to get more than one IP address from a conventional SP, the μSP will typically have to pay extra. A cost-saving alternative is to have the μSP router/server 220 implement NAT so that all μSP client computers 202a to 202d share a single global IP address. NAT is described in the article by K. Egevang and P. Francis, “The IP Network Address Translator (NAT),” RFC 1631, Internet Engineering Task

### Exemplary μSP Method

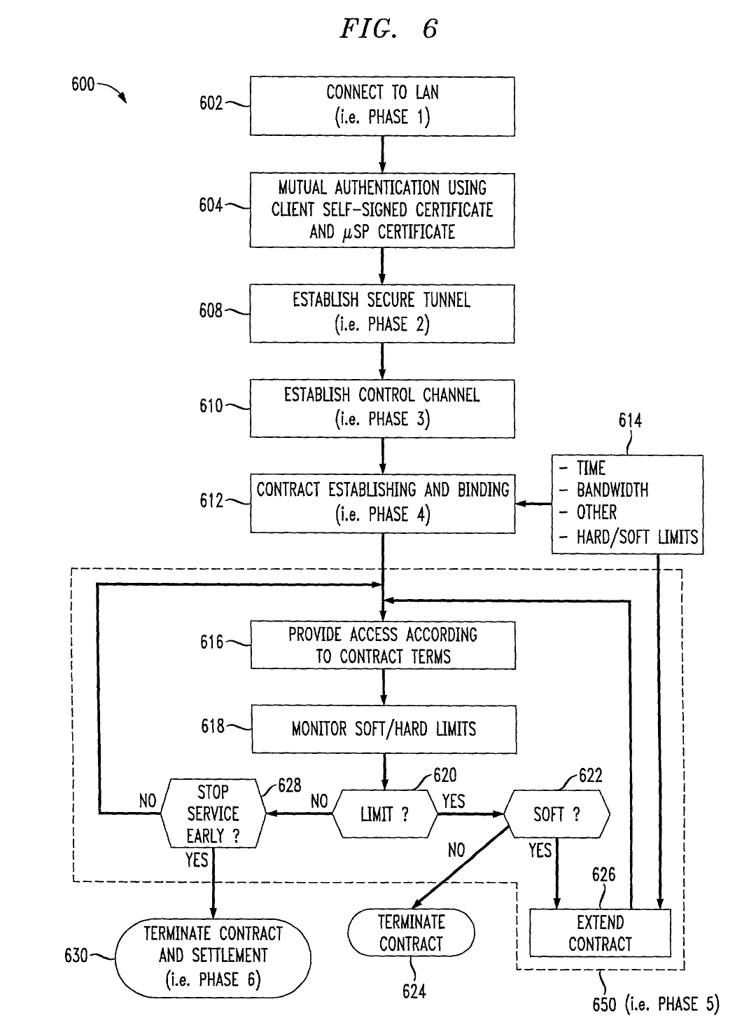

FIG. 6 shows one embodiment of method 600 performed between one of the client computers 202a to 202d (more specifically the exemplary client computer 202d shown in FIG. 2) and the computer components of the μSP router/server 220.

The method 600 starts with block 602 in which the client computer 202d is connected to the LAN 222 of the μSP 204. Standard configuration protocols may be used to establish this network connection, as described in the above network configuration (i.e., phase 1).

The method 600 continues in block 604, where the client computer 202d authenticates the μSP router/server 220. Authentication occurs in the initial phase of the Internet Key Exchange (IKE) negotiation for establishment of a secure tunnel as shown in block 608. In the IKE authentication, the client computer uses a self-signed certificate, whereas the μSP router/server 220 must provide a certificate signed by a recognized μSP certificate authority (CA).

The method 600 continues in block 608, where a secure tunnel is established between the client computer 202b and the μSP router/server 220. The method of authenticating the μSP and establishing a secure tunnel is detailed above in the secure tunnel establishment description, e.g., phase 2.

The secure tunnel stops nonpaying clients from gaining free service by fraudulently using the respective paying client's IP address. In one embodiment, μSP and each paying client computer 202a to 202d establish a secure tunnel using IPSec's IKE protocol. Paying client computers 202a to 202d then use IPSec's standard Authentication Header (AH) in tunnel mode to authenticate each packet they send to the μSP router/server.

Because AH authentication includes the packet's source address, and nonpaying client computers 202a to 202d do not have an authentication key, the μSP router/server 220 can easily detect and drop packets spoofed by a nonpaying client computer 202a to 202d.

In an alternative embodiment, the secure tunnel of block 608 would be established using the PPTP protocol, instead of AH. PPTP allows client and μSP to mutually authenticate each other and encrypts all data sent between the client computer and the μSP router/server. Because nonpaying clients do not have the necessary encryption keys, they are unable to send or receive intelligible data through the μSP router/server.

The method 600 continues in block 610 where the client computer 202 and μSP router/server 220 establish the control channel, as described in phase 3 above.

The method 600 continues in block 612, which represents contract establishing and binding, i.e., phase 4 of the μSP protocol. In block 612, a service contract is negotiated between the client 202d and the μSP 204. Negotiated contract terms 614 include how usage is to be measured (e.g., by time or bandwidth), the client's hard and soft usage limits, and payment method. The contract terms 614 are stored in the memory 242, and can be accessed by the CPU 240. Usage limits may be based upon connection time, packets transmitted, bandwidth required, quality of service provided, a combination of two or more of the above, or any other known parameter.

The client computer 202, based upon the user selection as to the desired services and options, generates a deposit payment and the desired options signal that is transmitted to the μSP router/server 220. The μSP router/server 220 receives the deposit payment and the desired options signal. The μSP router/server 220 then transmits a receipt signal to the client 202. The client computer 202 receives the receipt signal for the deposit payment from the μSP router/server 220 and commits the receipt to stable storage.

Many different usage metrics and payment methods may be desirable in a given μSP. Usage metrics may be, for instance, elapsed or usage time, or number of bytes or packets transmitted. The μSP defines a carefully designed protocol that supports these and other options. In particular, the μSP protocol does not require modifications in online payment method implementations because the protocol automatically and securely binds online payment, however implemented, with the secure tunnel of block 608.

The μSP architecture 200 can recover from computer crashes. In many scenarios, crashes are actually expected. For example, a guest at a hotel or conference center may turn her laptop on and off several times until her contract with the local μSP expires. The μSP protocol allows graceful recovery by issuing the client a receipt after the client pays. The μSP architecture authenticates the receipt using a secret key. If the usage metric is simply elapsed time, e.g., flat fee until an expiration time, the receipt contains all the information necessary for recovery and the μSP need not commit client state to stable storage, except for online payments. Recovery of crashes between the time the client sends online payment to the μSP and the time the client commits the respective receipt to stable storage is handled according to the respective payment method.

The method 600 continues in block 616, where access is provided for the client computer 202d via the μSP router/server 220 according to the contract terms established in block 612. One embodiment of the above-described phase 5, usage metering, includes those blocks within dotted box 650 (including blocks 616, 618, 620, 622, 626, and 628).

The method 600 continues in block 618, where the usage of the client computer 202d is monitored, and decision block 620, where the usage of client computer 202d is compared to the respective soft and hard usage limits. If, in decision block 620, it is determined that usage is not below the limits, then the method 600 continues in decision block 622, otherwise method 600 continues in decision block 628.

In decision block 622, the usage is compared to the soft limit. If, in decision block 622, it is determined that the usage is not below the soft limit, method 600 continues in block 626, otherwise method 600 continues in block 624.

In block 626, usage has reached the soft limit, and the μSP router/server 220 suspends service and sends a notification to the client computer 202d. The client may set a new soft limit and resume service by sending a message to the μSP router/server. In such a case, method 600 continues in block 616.

On the other hand, in block 624, usage has reached the hard limit, and the μSP router/server terminates the contract.

In decision block 628, the μSP router/server determines whether the client has requested contract termination. If the answer to decision block 628 is no, method 600 continues in block 616; otherwise, method 600 continues in block 630.

In block 630, the contract is settled and terminated, as outlined above in e.g., phase 6. Upon settlement in one embodiment, the client may receive a refund that equals the difference between the deposit made by the client in block 612 and the actual usage by the client computer 202d. Other refund schemes may be applied.

The μSP router/server 220 does not provide to client computers 202a to 202d local content and email or Web page hosting services. However, such lack of email or Web page hosting is not a disadvantage because owners of client computers 202a to 202d can easily find on the Web portals or servers that provide such services for free e.g., www.yahoo.com, www.hotmail.com, and www.geocities.com. Web-based services have the advantage of being accessible wherever the client may be. The μSP architecture uses the services of conventional SPs. The μSP architecture may be able to substantially reduce the cost of such services by implementing Network Address Translation (NAT) in the router between the μSP LAN and the shared access link. When NAT is used, all μSP client computers 202a to 202d use the same global IP address and appear to the conventional SP as a single host.

### Other Design Variations

Many details of the μSP architecture design can be altered without essentially impacting the overall functionality. This section discusses some of the possible modifications.

An obvious variation is to use another protocol for authentication and/or encryption in the secure tunnel. The new protocol must be able to encapsulate and decapsulate packets. For example, instead of AH, a μSP architecture might employ ESP's authentication option to authenticate packets sent by paying owners of client computers 202a to 202d. In either case, ESP's encryption is optional, and tunnel mode is used. Unlike AH, ESP's authentication does not cover the packet's source and destination IP addresses. However, ESP's authentication does cover the entire encapsulated packet. Therefore, ESP's authentication is sufficient for spoofing prevention.

One embodiment of the μSP protocol involves setting up the control channel before the secure tunnel is established. The control channel might allow, for example, the transmission of cryptographic keys to be used in the tunnel. In this case, IKE authentication could, for instance, use a pre-shared key, instead of digital signatures.

Other variations include using a solution other than the DHCP protocol for configuring networking parameters of client computers; using a solution other than the IKE protocol for establishing the secure tunnel's cryptographic algorithms and keys; using a firewall, instead of IPSec's SPDs, for dropping packets of nonpaying owners of client computers; or using a protocol other than TLS, e.g., Secure Sockets Layer (SSL) for the secure control channel.

### Performance

The performance of one embodiment of a μSP 204 is now discussed. While the performance of one embodiment of computer is described, it is envisioned that the concepts applied pertain to any other computer that could perform the operations required for the μSP 204. In one embodiment, the μSP router/server 220 uses a PC with a 400 MHz Pentium II CPU and 64 MB of main memory with the freely available LINUX™ 2.2.12 operating system and the FreeS/WAN 1.1 IPSec implementation. The prototype uses several of the design alternatives discussed in the previous section. First, the prototype uses SSL instead of TLS, because SSL implementations are easily available. Second, the prototype uses SSL to establish the control channel before the secure tunnel, because FreeS/WAN 1.1 does not fully implement IKE. The control channel securely transmits randomly generated keys for FreeS/WAN authentication using pre-shared keys.

Prototype client computers 202a to 202d and a prototype server computer 116 were configured each as a PC using the LINUX™ operating system and were connected to the prototype μSP router/server 220 using separate 10 Mbps Ethernets. Measurements of the throughput for TCP communication between client 202d and server 116, and the CPU utilization of the μSP router/server 220, were made under different circumstances. When client 202d and server 116 were connected directly on the same 10 Mbps Ethernet, without the μSP router/server 220, TCP throughput was 6.4 Mbps. When client 202d and server 116 were connected through the μSP router/server 220 performing only routing and Network Address Translation (NAT), with no security protocols, the TCP throughput was 6.2 Mbps and the CPU utilization was 4%. Using AH authentication with the MD5 algorithm for packets sent between the client 202d and the μSP router/server 220, the throughput decreased to 5.8 Mbps, and the CPU utilization increased to 26%. Finally, using ESP authentication with the MD5 algorithm and encryption with the triple DES algorithm, the throughput decreased to 5.3 Mbps, and the CPU utilization increased to 70%.

The time necessary for clients to connect to the μSP, including steps 1 to 4 of the μSP protocol, and the load imposed on the prototype μSP router/server's CPU by such connections, were also measured. Connections from two 100 MHz Pentium clients and one 700 MHz dual-processor Pentium III client were commenced. Connection took between 0.5 seconds and about 2.1 seconds. The CPU was 31% utilized during these connections.

These measurements suggest that even a modest PC can handle the loads that may be expected on a μSP router/server. Access links such as T1, DSL and cable provide bandwidths from 0.6 to 7 Mbps downstream and from 0.6 to 1.5 Mbps upstream. Cable can theoretically support up to 27 Mbps downstream, but cable modems usually limit a client's bandwidth to 1 Mbps. Such bandwidths are one to two orders of magnitude greater than those enabled by PSTN, 57 Kbps downstream and 33 Kbps upstream, but still represent only a moderate load for today's processors. The measurements also justify charging extra for privacy on the μSP's LAN: ESP's authentication (MD5) and encryption (triple DES) imposed a much higher load on the μSP router/server prototype than did AH's authentication (MD5) alone.

Although various embodiments incorporating the teachings of the present invention have been shown and described in detail herein, those skilled in the art can readily devise many other varied embodiments that still incorporate these teachings.

1. A method for providing client access to the Internet or other network, comprising:
offering, at a point of service, a Local Area Network (LAN) connected to the Internet or other network;
connecting at least one client computer to said LAN;
configuring networking parameters of each of said at least one client computer;
establishing a secure tunnel between the service provider and each of said at least one client computer, such that the service provider provides Internet or other network service through the secure tunnel to only each one of said at least one client computer;
negotiating, at the point of service, the network usage terms and prices with each one of said at least one client computer; and
providing the Internet or other network service at the point of service to each one of the at least one client computer in accordance with the network usage terms and prices.

2. The method of claim 1, further comprising establishing a contract at the point of service wherein the contract defines the network usage terms and prices negotiated between the client and the service provider.

3. The method of claim 2 wherein the contract does not depend on a previous or subsequent relationship between client and service provider.

4. The method of claim 2 wherein the user of the client computer may select as short a contract term as the user of the client computer desires.

5. The method of claim 2 wherein the client's usage is measured by bytes or packets transmitted or received, or by the contract's active or elapsed time.

6. The method of claim 2 wherein the client may choose a hard usage limit, such that the service provider terminates the contract when the hard limit is reached.

7. The method of claim 2 wherein the user of the client computer may request contract termination.

8. The method of claim 2 where, after receiving a deposit, the service provider sends to the client computer a receipt that the client computer may use to recover from a client computer or service provider failure, obtaining access again on the same contract.

9. The method of claim 8 wherein the receipt contains all the information required for recovery.

10. The method of claim 2 wherein the contract is established and the client may monitor and control its usage via a Transport Layer Security protocol or via a Secure Socket Layer connection.

11. The method of claim 1 wherein the service provider owns or rents the premises at the point of access.

12. The method of claim 1 wherein access is provided in one of an airport, hotel, conference center, or a multi-tenant building.

13. The method of claim 1 wherein a service provider that provides the client access obtains access services from another service provider, e.g., an Internet Service Provider (ISP).

14. The method of claim 1 wherein a service provider that provides client access is connected to the Internet by one or more Digital Subscriber Lines (DSL), T1 or other dedicated telephone lines, Integrated Services Digital Network (ISDN) lines, or cable modems.

15. The method of claim 1 wherein a service provider that provides the client access uses Network Address Translation.

16. The method of claim 1 wherein the network configuration of client computers is automatic.

17. The method of claim 16 wherein the network configuration of client computers is performed by the Dynamic Host Configuration Protocol.

18. The method of claim 1 where packets sent from the client computer to or via a service provider are authenticated.

19. The method of claim 1 where packets sent from or via a service provider to the client computer are authenticated.

20. The method of claim 1 where packets sent between the client computer and a service provider are encrypted.

21. The method of claim 1 wherein the client computer may choose whether packets sent from or via a service provider to the client computer should be authenticated, or whether packets sent between the client computer and a service provider should be encrypted.

22. The method of claim 1 wherein the client may choose how a service provider measures the client's usage.

23. The method of claim 1 wherein the client may choose a soft usage limit, such that the service provider suspends service to the client when the soft limit is reached and sends a notification to the client, and the client may resume service and set a new soft limit by sending a message to the service provider.

24. The method of claim 1, further comprising the client paying for said Internet or other network service, wherein the payment is offline.

25. The method of claim 24 wherein payment is by one or more of the following options: cash, credit card, and debiting from another account.

26. The method of claim 1, further comprising the client paying for said Internet or other network service, wherein the payment is online.

27. The method of claim 26 wherein payment is by one or more of the following options: eCASH®, SECURE ELECTRONIC TRANSACTIONS (SET)®, IBM MICROPAYMENTS®, or MILLICENT®.

28. The method of claim 26 wherein online payment, no matter how implemented, is performed through an authenticated and/or encrypted tunnel, and therefore is automatically and securely bound to it.

29. The method of claim 1, further comprising paying for said Internet or other network service, wherein a user of the client computer can choose the payment method or a combination of payment methods.

30. The method of claim 1 wherein the user of the client computer may monitor and control the client computer usage.

31. The method of claim 1 wherein the user of the client computer, before gaining service, pays to the service provider a deposit corresponding to a hard usage limit.

32. The method of claim 31 wherein the user of the client computer, before gaining service, pays to the service provider a deposit, and, when the user requests contract termination, the service provider returns to the user the difference between the deposit and actual usage.

33. The method of claim 1 wherein the client computers are not portable.

34. The method of claim 1 wherein the client computers are portable.

35. The method of claim 1 wherein the client computers are wearable.

36. The method of claim 1 wherein the LAN conforms to a standard.

37. The method of claim 36 wherein the LAN is an Ethernet.

38. The method of claim 36 wherein the LAN is an 802.11 wireless network.

39. The method of claim 1 wherein security protocols used by the secure tunnel are standard.

40. The method of claim 39 wherein the security protocols belong to the IPSec protocol suite of the Internet Engineering Task Force (IETF).

41. The method of claim 40 wherein the client computer uses a self-signed certificate.

42. The method of claim 40 wherein the service provider uses a certificate signed by a Certification Authority (CA).

43. The method of claim 42 wherein the Certification Authority (CA) has special procedures for certifying service providers.

44. The method of claim 42 wherein the certificate includes the location and type of LAN used by the service provider.

45. The method of claim 42 wherein the packets sent from the client computer to or via the service provider are authenticated using IPsec's Authentication Header (AH).

46. The method of claim 42 wherein the packets sent from or via the service provider to the client computer may be authenticated using IPsec's Authentication Header (AH).

47. The method of claim 42 wherein the packets sent between client computer and a service provider may be authenticated and/or encrypted using IPsec's Encapsulating Security Payload (ESP).

48. The method of claim 41 wherein the security protocol is Point-to-Point Tunneling Protocol (PPTP).

49. The method of claim 1 wherein the user of the client computer does not reveal its identity to the service provider.

50. The method of claim 1 wherein a secure connection is established between client and service provider, and wherein the secure connection is used to communicate secrets used for establishing a secure tunnel between those parties.

51. The method of claim 1 wherein service provider functionality is implemented by an integrated router/server.

52. The method of claim 1 wherein service provider functionality is implemented by separate router and server.

53. A method for providing metered access to the Internet, comprising:
accessing, via a local area network (LAN), the Internet, utilizing a service provider;
establishing a secure tunnel with said service provider by exchanging authentication certificates with said service provider;
negotiating network usage terms with said service provider at a point of access to the Internet; and
accessing said Internet via said service provider according to said negotiated usage terms.

54. The method of claim 53, wherein a self-signed authentication certificate is provided to said service provider during said authentication.

55. The method of claim 53, wherein said usage terms are defined in terms of one of time and bandwidth.

56. The method of claim 53, wherein the contact established between the client and the service provider to access the Internet can last for a duration selected by the client.

57. An apparatus for providing client access to the Internet or other network, the apparatus comprising:
a Local Area Network (LAN) to which client computers can be connected;
a router that connects the LAN to the Internet or other network;
a secure tunnel established between each client computer and the router, such that the router forwards to the Internet or other network only packets sent from the
a server computer with which client computers communicate to negotiate, control, and settle access contracts wherein the server computer controls the router to establish or tear down each client computer's secure tunnel.
